(19) United States
(12) Patent Application Publication
(10) Pub. No.: US 2025/0307516 A1
(43) Pub. Date: Oct. 2, 2025

(54) AUTOMATED PCB DESIGN AND ANALYSIS SYSTEM

(71) Applicant: Think Circuits LLC, Lafayette, CA (US)

(72) Inventors: Kevin Weekly, Lafayette, CA (US); Michael C. Lorek, Sacramento, CA (US); Hiten Sonpal, Bedford, MA (US)

(73) Assignee: Think Circuits LLC, Lafayette, CA (US)

(21) Appl. No.: 19/091,754

(22) Filed: Mar. 26, 2025

Related U.S. Application Data
(60) Provisional application No. 63/571,120, filed on Mar. 28, 2024.

(51) Int. Cl. G06F 30/392; G06F 115/12

(52) U.S. Cl. CPC G06F 30/392; G06F 2115/12

(57) ABSTRACT

A computerized system for circuit design review and analysis can include an automated machine analysis engine running in a processor and operable to execute a BOM evaluation of a PCB design, a schematic analysis engine running in the processor and operable to analyze a schematic diagram associated with the PCB design, a PCB layout analysis engine running in the processor and operable to analyze a PCB layout associated with the PCB design, a PCB manufacturability analysis engine running in the processor and operable to analyze the PCB layout of the PCB design in combination with the BOM to validate manufacturability of the PCB design, and a design modification engine running in the processor and configured to generate a screen display object on a human-machine interface illustrating the data and/or a change to the BOM, the schematic diagram, and/or the PCB layout.

### CROSS REFERENCE TO RELATED APPLICATIONS

This application claims priority to, and the benefit of, U.S. Provisional Patent Application Ser. No. 63/571,120, entitled “AUTOMATED PCB DESIGN AND ANALYSIS SYSTEM,” filed on Mar. 28, 2024. The '120 application is hereby incorporated by reference in its entirety for all purposes.

### FIELD

The present disclosure relates generally to printed circuit boards, and more specifically, to systems and methods for PCB design analysis and optimization.

### BACKGROUND

A printed circuit board (PCB) is a carrier of various electronic components. PCBs are used in almost all modern electronic products. With continuous development of technology and PCB industry's manufacturing capability, electronic products are becoming lighter, thinner, and smaller, pushing PCB development towards high density, small components, fine pitch, and more layers, which makes PCB quality inspection increasingly challenging.

A PCB design layout is generally the last step in circuit design. After a PCB layout is completed, bare board manufacturing of the PCB starts. The bare board manufacturing of the PCB is completed on the basis of PCB design data (e.g., Gerber files and hole data). Therefore, the PCB design layout is the premise and foundation of PCB manufacturing, and quality of the design can determine the quality of the entire PCB and even the electronic product.

### SUMMARY

One aspect of the subject matter described in this disclosure may be embodied in a computerized system for circuit design review and analysis. The computerized system can include an automated machine analysis engine running in a processor and operable to execute a bill of materials (BOM) evaluation of a printed circuit board (PCB) design. The computerized system can include a schematic analysis engine running in the processor and operable to analyze a schematic diagram associated with the PCB design. The computerized system can include a PCB layout analysis engine running in the processor and operable to analyze a PCB layout associated with the PCB design. The computerized system can include a PCB manufacturability analysis engine running in the processor and operable to analyze the PCB layout of the PCB design in combination with the BOM to validate manufacturability of the PCB design. The computerized system can include a physics interaction analysis engine running in the processor and operable to analyze the PCB design to identify electromagnetic behavior of at least one feature of a simulated manufactured device including the PCB design, wherein the electromagnetic behavior is deleterious. The computerized system can include a design modification engine running in the processor and configured to (i) ingest at least one datum provided by each of the automated machine analysis engine, the schematic analysis engine, the PCB layout analysis engine, the PCB manufacturability analysis engine, and the physics interaction analysis engine, and (ii) generate at least one of (1) a screen display object on a human-machine interface illustrating the data and (2) a change to at least one of the bill of materials, the schematic diagram, and the PCB layout in response to the at least one datum.

In various aspects, the design modification engine is further configured to generate a modified PCB design based upon the change to at least one of the bill of materials, the schematic diagram, and the PCB layout.

In various aspects, the computerized system further comprises an artificial intelligence (AI) checker running in the processor and operable to receive the modified PCB design from the design modification engine and detect an error in the modified PCB design using a machine learning model.

In various aspects, the AI checker is further operable to send the error to the design modification engine.

In various aspects, the design modification engine is further operable to (1) further modify to the modified PCB design based on the error received from the AI checker to generate a doubly modified PCB design and (2) send the doubly modified PCB design to the AI checker to detect any errors in the doubly modified PCB design.

In various aspects, the schematic analysis engine is configured to receive a netlist associated with the PCB design, check netlist connectivity using the netlist associated with the PCB design, create a netlist with attributes, and check whether components of the PCB design are compatible based upon the netlist with attributes.

In various aspects, the PCB layout analysis engine is configured to receive a PnP file associated with the PCB design, a Gerber file associated with the PCB design, and a drill file associated with the PCB design, generate a labelled Gerber file, and generate a connectivity graph using the labelled Gerber file.

Another aspect of the subject matter described in this disclosure may be embodied in a computer-implemented method for circuit design review and analysis. The method can include receiving, by a processor, a PCB design data comprising a bill of materials (BOM) for a PCB design and the PCB design. The method can include evaluating, by the processor, the BOM for the PCB design to generate a first PCB design datum. The method can include analyzing, by the processor, a schematic diagram associated with the PCB design to generate a second PCB design datum. The method can include analyzing, by the processor, a PCB layout associated with the PCB design to generate a third PCB design datum. The method can include analyzing, by the processor, the PCB layout associated with the PCB design in combination with the BOM to validate manufacturability of the PCB design to generate a fourth PCB design datum. The method can include analyzing, by the processor, the PCB design to identify electromagnetic behavior of at least one feature of a simulated manufactured device including the PCB design to generate a fifth PCB design datum, wherein the electromagnetic behavior is deleterious. The method can include analyzing, by the processor, the first datum, the second datum, the third datum, the fourth datum, and the fifth datum to generate at least one of (1) a screen display object on a human-machine interface illustrating the data and (2) a change to at least one of the bill of materials, the schematic diagram, and the PCB layout in response to the first datum, the second datum, the third datum, the fourth datum, and the fifth datum.

In various aspects, the computer-implemented method further comprises generating, by the processor, a modified PCB design based upon the change to at least one of the bill of materials, the schematic diagram, and the PCB layout.

In various aspects, the computer-implemented method further comprises detecting, using a machine learning model, an error in the modified PCB design.

In various aspects, the computer-implemented method further comprises modifying, by the processor, the modified PCB design based on the error to generate a doubly modified PCB design and detecting, using the machine learning model, a second error in the doubly modified PCB design.

In various aspects, the computer-implemented method further comprises receiving a netlist associated with the PCB design, checking netlist connectivity using the netlist associated with the PCB design, creating a netlist with attributes, and checking whether components of the PCB design are compatible based upon the netlist with attributes.

In various aspects, the computer-implemented method further comprises receiving a PnP file associated with the PCB design, a Gerber file associated with the PCB design, and a drill file associated with the PCB design, generating a labelled Gerber file, and generating a connectivity graph using the labelled Gerber file.

Another aspect of the subject matter described in this disclosure may be embodied in a non-transitory machine-readable storage medium operable on a computer. The non-transitory machine-readable storage medium can comprise instructions that, when executed, cause at least one processor of the computer to receive a PCB design data comprising a bill of materials (BOM) for a PCB design and the PCB design, evaluate the BOM for the PCB design to generate a first PCB design datum, analyze a schematic diagram associated with the PCB design to generate a second PCB design datum, analyze a PCB layout associated with the PCB design to generate a third PCB design datum, and analyze the PCB layout associated with the PCB design in combination with the BOM to validate manufacturability of the PCB design to generate a fourth PCB design datum. The instructions can, when executed, further cause at least one processor of the computer to analyze the PCB design to identify electromagnetic behavior of at least one feature of a simulated manufactured device including the PCB design to generate a fifth PCB design datum, wherein the electromagnetic behavior is deleterious. The instructions can, when executed, further cause at least one processor of the computer to analyze the first datum, the second datum, the third datum, the fourth datum, and the fifth datum to generate at least one of (1) a screen display object on a human-machine interface illustrating the data and (2) a change to at least one of the bill of materials, the schematic diagram, and the PCB layout in response to the first datum, the second datum, the third datum, the fourth datum, and the fifth datum.

In various aspects, the instructions, when executed, further cause the at least one processor of the computer to generate a modified PCB design based upon the change to at least one of the bill of materials, the schematic diagram, and the PCB layout.

In various aspects, the instructions, when executed, further cause the at least one processor of the computer to detect, using a machine learning model, an error in the modified PCB design.

In various aspects, the instructions, when executed, further cause the at least one processor of the computer to modify the modified PCB design based on the error to generate a doubly modified PCB design.

In various aspects, the instructions, when executed, further cause the at least one processor of the computer to detect, using the machine learning model, a second error in the doubly modified PCB design.

In various aspects, the instructions, when executed, further cause the at least one processor of the computer to receive a netlist associated with the PCB design, check netlist connectivity using the netlist associated with the PCB design, create a netlist with attributes, and check whether components of the PCB design are compatible based upon the netlist with attributes.

In various aspects, the instructions, when executed, further cause the at least one processor of the computer to receive a PnP file associated with the PCB design, a Gerber file associated with the PCB design, and a drill file associated with the PCB design, generate a labelled Gerber file, and generate a connectivity graph using the labelled Gerber file.

The foregoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the drawing figures, wherein like numerals denote like elements.

FIG. 1 is a block diagram of a system for PCB design and analysis, in accordance with various examples.

FIG. 2 is a flow chart for a PCB design method performed by the system of FIG. 1, in accordance with various examples.

FIG. 3 is an example display of screen display objects illustrating example data generated by the system of FIG. 1, in accordance with various examples.

### DETAILED DESCRIPTION

The detailed description of exemplary embodiments herein makes reference to the accompanying drawings, which show exemplary embodiments by way of illustration. While these exemplary embodiments are described in sufficient detail to enable those skilled in the art to practice the disclosure, it should be understood that other embodiments may be realized and that logical changes and adaptations in design and construction may be made in accordance with this disclosure and the teachings herein. Thus, the detailed description herein is presented for purposes of illustration only and not of limitation. The scope of the disclosure is defined by the appended claims. For example, the steps recited in any of the method or process descriptions may be executed in any order and are not necessarily limited to the order presented. Furthermore, any reference to singular includes plural embodiments, and any reference to more than one component or step may include a singular embodiment or step.

It must also be noted that, the term “exemplary” is used in the sense of “example,” rather than “ideal.”

It must also be noted that, as used in the specification and the appended claims, the singular forms “a,” “an” and “the” include plural referents unless the context clearly dictates otherwise.

By “comprising” or “containing” or “including” it is meant that at least the named compound, element, particle, or method step is present in the composition or article or method, but does not exclude the presence of other compounds, materials, particles, method steps, even if the other such compounds, material, particles, method steps have the same function as what is named.

Relative terms, such as “about,” “substantially,” or “approximately” are used to include small variations with specific numerical values (e.g., +/−x %), as well as including the situation of no variation (+/−0%). In various embodiments, the numerical value x is less than or equal to 10—e.g., less than or equal to 5, to 2, to 1, or smaller.

As used herein, “database” refers to any suitable database for storing information, electronic files or code to be utilized to practice embodiments of this disclosure.

As used herein, “artificial intelligence” or AI refers to any process or approach that can allow a computing device(s) to mimic human intelligence. AI can include, though is not necessarily limited to, machine learning, neural network computing, knowledge bases, representation learning, and deep learning.

As used herein, “machine learning” or ML refers to a subclass of AI that can allow a machine to obtain or learn information by identifying and/or extracting patterns from data. ML techniques of this disclosure can include, but are not limited to SVMs, logistic regression, decision trees, Naïve Bayes classifiers, and neural networks.

As used herein, “neural network” refers to any kind of network architecture that can include several interconnected nodes and include one or more “deep learning” algorithms. The output of the mode can depend on the input, a weight, a bias and an activation function. The output of some nodes can be connected to the input of other nodes forming a directed, weighted output where vertices or edges of the output are associated with weights, respectively.

As used herein, “deep learning” refers to a subset of ML that that enables a machine to automatically discover representations needed for feature detection, prediction, classification, etc. using layers of processing. Deep learning techniques include, but are not limited to, artificial neural network or multilayer perceptron (MLP).

As used herein, “server” refers to any suitable server, computer or computing device for performing functions utilized to practice embodiments of this disclosure.

As used herein, “software” refers to programs or other operating information utilized by a processor or other computing hardware.

As used herein, “a computer storage medium” can be, or be included in, a computer-readable storage device, a computer-readable storage substrate, a random or serial access memory array or device, or a combination of one or more of the substrates and devices. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., solid-state memory that forms part of a device, disks, or other storage devices). In accordance with examples of the disclosure, a non-transient computer readable medium containing program can perform functions of one or more methods, modules, engines and/or other system components as described herein.

As used herein, “tangible, non-transitory memory” refers to computer program instructions, encoded on computer storage medium for execution by, or to control the operation of, data processing apparatus. Alternatively, or additionally, the program instructions can be encoded on an artificially-generated propagated signal, e.g., a machine-generated electrical, optical, or electromagnetic signal, which is generated to encode information for transmission to a suitable receiver apparatus for execution by a data processing apparatus. A computer storage medium can be, or be included in, a computer-readable storage device, a computer-readable storage substrate, a random or serial access memory array or device, or a combination of one or more of the substrates and devices. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., solid-state memory that forms part of a device, disks, or other storage devices). In accordance with examples of the disclosure, a non-transient computer readable medium containing program can perform functions of one or more methods, modules, engines and/or other system components as described herein. The computer storage medium can also be, or be included in, random access memory (RAM), read-only memory (ROM), electronically erasable programmable ROM (EEPROM), flash memory or other memory technology, compact disc ROM (CD-ROM), digital versatile disks (DVD) or other optical storage, magnetic cassettes, magnetic tape, magnetic disk storage or other magnetic storage devices, or any other tangible, physical medium which can be used to store computer readable information.

As used herein, the terms application, module, analyzer, generator, engine, and the like can refer to computer program instructions, encoded on computer storage medium for execution by, or to control the operation of, data processing apparatus. Alternatively, or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of the substrates and devices. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., solid-state memory that forms part of a device, disks, or other storage devices).

As used herein, the terms “component,” “engine,” “model,” “module,” “system,” “server,” “processor,” “memory,” and the like are intended to include one or more computer-related units, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Disclosed herein are computerized systems and methods for the automated design review and analysis of circuits, such as printed circuit board (PCB) circuits. A PCB design and analysis system may include one or more processors, connecting circuit components, interfaces, level converters, IO devices, and/or memory operable to perform the methods herein.

The automated review system disclosed herein in various embodiments can evaluate approximately 100, or more, different aspects or features (“points”) of a design, reducing manufacturing and other mistakes. In various embodiments, the systems, methods, and apparatuses herein identify aspects such as incorrect pin numbers, footprint mismatches, voltages that are out of range such as too high or too low. Accordingly, retooling and other costly manufacturing operations may be reduced or eliminated. Further aspects of the system, method, and apparatus evaluate potential components, traces, trace geometry, and other architecture for potential problems. In various embodiments, signal integrity, over current, over voltage, mechanical fitment, and other issues are addressed. In various embodiments, proactive practices are identified and implemented by the automated system to enhance testability, and debuggability of designs. As such, design for test (DFT) solutions are delivered automatically.

The automated process may include multiple steps. For instance, a method may include analysis from more general to more specific architectural features. In various embodiments, a method may include a holistic design evaluation aspect, an intricate review aspect such as of one or more schematic and/or layout, and a follow-up revisionary aspect.

More specifically, the automated process may include features detailed below. In various instances, the process includes analysis of high-level requirements and specifications to determine an appropriateness of bill of materials selections. In various embodiments, the automated process may evaluate microcontroller or other processor selections, and additional components for aspects such as speed, memory, and power usage.

The automated process may include an intricate machine analysis of a schematic diagram and/or a PCT layout. For instance, the process may evaluate each part, pin, trace, etc. for important issues such as improper labeling, mixed TX and RX pins, current and voltage capacity, parasitic interactions and/or frequency-dependent concerns such as may be introduced by trace geometries, shielding, and/or the like. A design-for-manufacture (DFM) check may proceed to verify manufacturability consistent with practical limitations organized and ingested by the machine process from a manufacturing third-party.

Furthermore, the processes as disclosed herein in various embodiments may include identification of problems, potential problems, and available improvements for a design. Moreover, the process may generate testing protocols for quality assurance validation of produced PCB circuits following manufacturing. Thus, the automated process may both design a PCB circuit for manufacturability, ameliorate errors and malfunctions, then generate a test protocol for post-manufacturing quality assurance of the same.

In various embodiments, certain test sequences may be implemented. Various non-limiting sets of test sequences are provided below as useful examples.

For instance, RF test sequences may be implemented to evaluate radio frequency compliance of a PCB circuit. Such tested aspects may include elements in the Table 1 below:

TABLE 1
RF Test Sequences
RF Test Sequence

Crystal cap value,
dielectric (tempco)
Antenna ground plane
requirements
Routing from TX −>
balun? −> antenna (match target
controlled impedance layout as
much as possible)

In various embodiments, connector test sequences may be implemented. For example, such tested aspects may include elements in the Table 2 below:

TABLE 2
Connector Test Sequences
Connector Test Sequence

Use 3-d models to verify
clearance, usability
Pin voltage/current

In various embodiments, test sequences associated with integrated circuits (ICs) may be implemented. In one such illustrative scenario, such tested aspects may include elements in the Table 3 below, and may proceed in a piece-wise and/or recursive manner evaluating a plurality of ICs associated with a PCB:

TABLE 3
IC Test Sequences
ICs Test Sequence

Per IC:
Verify
correct rotation, pin1,
view in datasheet (top-
down, bottom-up)
Route
shorts between pads as
u-shape (easier to cut if
needed)
Test points
for probing?

In various embodiments, test sequences associated with controlling of impedance may be implemented. For example, such tested aspects may include elements in the Table 4 below:

TABLE 4
Controlled Impedance Test Sequences
Controlled Impedance Test

Sequence
Trace width/spacing
matches recommended design from
PCB fab?
Length matching within
a diff pair
Vias/components
between diff pair?
Spacing between diff
pairs
Keep out around all
controlled impedance traces
Ground plane
uniformity (return path)

In various embodiments, test sequences associated with electromagnetic (EM) compliance may be implemented. For example, such tested aspects may include elements in the Table 5 below:

TABLE 5
EM Compliance Test Sequences
EM Compliance
Test Sequence

Sharp
corners
Shielding
Ground
plane uniformity

In various embodiments, test sequences associated with high-voltage design considerations (such as for PCBs with high voltage aspects) may be implemented. For example, such tested aspects may include elements in the Table 6 below:

TABLE 6
High voltage Design Test Sequences
High-Voltage Design Test Sequence

Creepage
Clearance
PCB
dielectric

In various embodiments, test sequences associated with various other important aspects may be implemented. For example, such tested aspects may include elements in the Table 7 below:

TABLE 7
Additional Test Sequences
Additional Test Sequence

Per ic decoupling caps:
Voltage rating, value, package,
dielectric vs datasheet
Routing length to ic
Routing length to ground plane via
Check regulator stability
recommendations in datasheet
Routing length to output and/or
control node caps
Worst-case ir drop across board~sum
(resistivity*length*imax/width)
Sensitive high-z traces? Limit
cpar*dv/dt to other signals
Print pcb specs in notes/fab layer
(layer count, finished thickness, trace/space,
dielectric type, min via size, controlled
impedance? Etc.)
How many drill sizes? Can reduce
cost if reduce number of drills

Further review items may be provided. For instance. Table 8 provides additional checks that may be varied in different situations:

TABLE 8
Additional Checks That May Be Varied

Check high level Requirements
Are all the requirements enumerated?
Check existence of each functionality
Check accuracy of each functionality
Check speed (e.g., sample rate of each
functionality)
Check external interfaces
Non-passive components
Retrieve Datasheets
Check price and availability
Passive components
Check price and availability
Check tolerance, voltage and current
handling, tempco
Polarity Check
For passives, confirm calculated power
dissipation vs. package power dissipation
Check termination resistor locations
Main MCU Checks
MCU Feasibility - Is CPU fast enough for
algorithms
MCU Feasibility - Enough memory
MCU Feasibility - Power states, what is
available at each power state
MCU Power supplies
MCU Clock supplies
Design tools available?
Libraries and external tools available?
Pin check - Schematic matches datasheet.
Pin name, pin number, function,
input/output capability, voltage tolerance
Pin check - Ease of development (do pin
choices match peripherals)
Pin check - ease of routing
MCU Programming & Debug interface
MCU Other testpoints needed
MCU Reset circuit
Check supporting circuitry
Footprint Check
For ICs, confirm environmental temperature
range requirement vs. part temperature
rating
Floating pins pulled high or low
Peripheral device checks
Power supply - voltage, current & noise
requirements
Power states analysis
Communications bus requirements - speed
etc.
Pin check - Schematic matches datasheet.
Pin name, pin number, function,
input/output capability, voltage tolerance
Pin check ease of routing
Pin optimization - alternate pin choices,
IRQ lines connected?
Test points needed
Reset circuit
Check supporting circuitry matches
datasheet
Footprint check per part
Footprint check per pin
For ICs, confirm environmental temperature
range requirement vs. part temperature
rating
Floating pins pulled high or low
Net Checks
Voltage and currents on the net
Compute trace width and spacing for
voltage & current
Frequency analysis of net
Noise susceptibility of net
Check only one driver per net
Check via sizes
Comms bus check
Check correct pins are connected on bus
Check bus speed compatibility
Check proper termination
Check for address conflicts
External connectors have ESD protection,
current protection
PCB Checks
Setup DFM Checks per net
Review Trace & space settings for MFG
High frequency trace inspection
High impedance / analog trace inspection
Check silkscreen printability
Check radiator traces or inefficient routing
Basic mechanical fitment & useability
Ground plane connectivity
Check power/ground islands around high
power switching ckts

Finally, further design checks may be appropriate in all or part and/or in combination with those mentioned above. Moreover, one may appreciate that aspects of these checks may be integrated into one or more aforementioned Table:

TABLE 9
Additional Checks That May Be Integrated

Thermals (Schematic)
For ICs, confirm environmental temperature range requirement
vs. part temperature rating
For passives, confirm calculated power dissipation vs. package
power dissipation
Cost (Reporting)
Cost analysis and recommendations? Could do this by just
running the BOM and the PCB design through online high-
volume manufacturers.
Size (Reporting)
Check size target vs. total area of the components (including
pads / pins)
Power Traces (PCB)
Confirm vias in power traces can carry expected current
Confirm termination resistor locations (series / parallel / AC)
ICs (Schematic)
Floating input pins pulled high or low
Power Supplies and Motor Drivers (PCB)
Confirm Kelvin connector for current sensor resistor
Confirm ground / power plane islands around high power
switching circuits in mixed signal designs
External Interfaces (Schematic)
Ensure that external interfaces are designed ESD-safe
EMI filtering placed next to connectors
Current limiting on external input pins
Battery Powered Devices (Schematic)
Run-time requirements vs. idle power consumption
Minimum power supply voltage spec is met by the battery's
nominal voltage
DFM (PCBA)
Fiducials present?
Analog Signals (Schematic)
Op amp designs are stable
Signal Integrity (PCB)
Test points are not on stubs

In view of the preceding discussion, one may appreciate that an example implementation may include a combination of the features.

For instance, a system may include an automated machine analysis engine running in a processor and operable to execute a first bill of materials (BOM) evaluation of a printed circuit board (PCB) design. The system may include a schematic analysis engine running in the processor and operable to analyze a schematic diagram associated with the PCB design. The system may include a PCB layout analysis engine running in the processor and operable to analyze a PCB layout associated with the PCB design. The system may include a PCB manufacturability analysis engine running in the processor and operable to analyze the PCB layout of the PCB design in combination with the BOM to validate manufacturability of the PCB design. The system may include a physics interaction analysis engine running in the processor and operable to analyze the PCB design to identify electromagnetic behavior of at least one feature of a simulated manufactured device including the PCB design, wherein the electromagnetic behavior is deleterious. The system may include a design modification engine running in the processor. The design modification engine may be configured to (i) ingest at least one datum provided by each of the automated machine analysis engine, the first schematic analysis engine, the first PCB layout analysis engine, the first PCB manufacturability analysis engine, and the first physics interaction analysis engine. The design modification engine may be configured to (ii) generate at least one of (1) a screen display object on a human-machine interface illustrating the data and (2) a change to at least one of the bill of materials, the schematic diagram, and the PCB layout in response to the at least one datum.

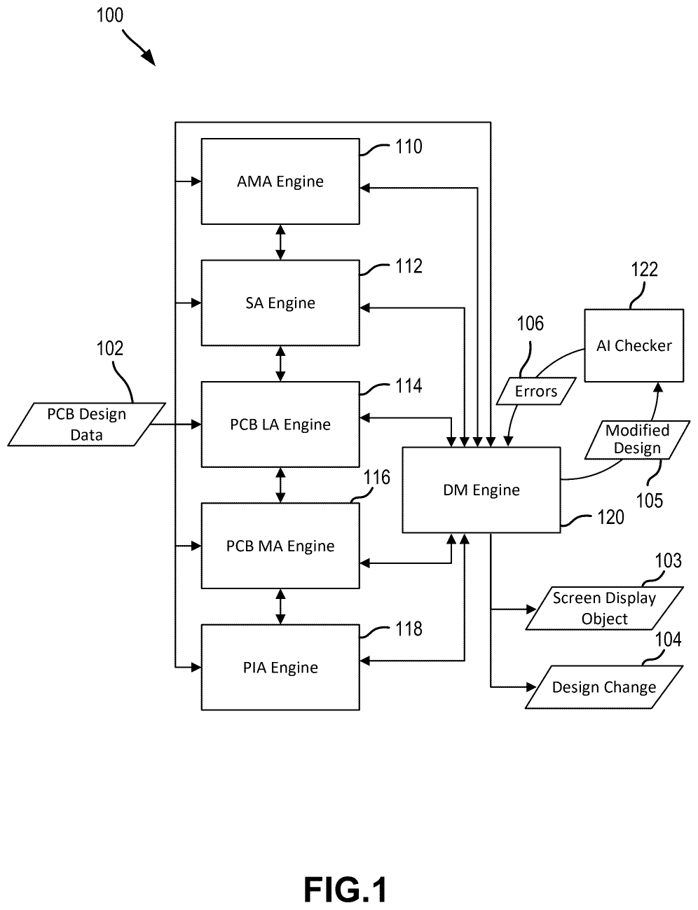

FIG. 1 is a block diagram of a system 100 for PCB design review and analysis, in accordance with various aspects. The system 100 can receive PCB design data 102. PCB design data 102 can include a bill of materials (BOM) for a circuit, a schematic diagram for the circuit, and/or other circuit design data (e.g., Gerber files, design methods (e.g., Press n Peel), hole data, PCB Netlist, etc.).

The system 100 may include an automated machine analysis engine 110. The schematic analysis engine 112 can be configured to receive the PCB design data 102. The automated machine analysis engine 110 can be operable to execute a BOM evaluation of a PCB design using the PCB design data 102.

The system 100 may include a schematic analysis engine 112. The schematic analysis engine 112 can be configured to receive the PCB design data 102. The schematic analysis engine 112 can be operable to analyze a schematic diagram associated with the PCB design. The schematic analysis engine 112 may confirm, for example, whether all the components fit onto a PCB of a predetermined size and/or whether any components missing.

In various aspects, the schematic analysis engine 112 performs one or more of the tasks/checks listed in Table 8. The schematic analysis engine 112 can not only perform checks on the physical traces and vias, etc., but can perform checks to learn semantic information about the purpose of those traces.

The system 100 may include a PCB layout analysis engine 114. The PCB layout analysis engine 114 can be configured to receive the PCB design data 102. The PCB layout analysis engine 114 can be operable to analyze a PCB layout associated with the PCB design. For example, the layout analysis engine 114 may determine whether a USB port (or other port) is blocked by an adjacent component.

In various aspects, the PCB layout analysis engine 114 can check termination resistor locations, check footprint, check footprint per part, check footprint per pin, check via sizes, check radiator traces or inefficient routing, perform high frequency trace inspection, and/or perform high impedance/analog trace inspection.

The system 100 may include a PCB manufacturability analysis engine 116. The PCB manufacturability analysis engine 116 can be configured to receive the PCB design data 102. The PCB manufacturability analysis engine 116 can be operable to analyze the PCB layout of the PCB design in combination with the BOM to validate manufacturability of the PCB design. For example, the PCB manufacturability analysis engine 116 can determine whether the PCB tooling is capable of manufacturing the circuit as designed.

In various aspects, the PCB manufacturability analysis engine 116 can setup DFM checks per net, review trace & space settings for manufacturing, check silkscreen printability, check radiator traces or inefficient routing, check basic mechanical fitment & useability, check ground plane connectivity, and/or check power/ground islands around high power switching circuits.

The system 100 may include a physics interaction analysis engine 118. The physics interaction analysis engine 118 can be configured to receive the PCB design data 102. The physics interaction analysis engine 118 can be operable to analyze the PCB design to identify electromagnetic behavior of at least one feature of a simulated manufactured device including the PCB design, wherein the electromagnetic behavior is deleterious. In various aspects, the physics interaction analysis engine 118 can comprise and/or utilize a computer electromagnetic simulation suite that models electric and magnetic field evolution. The physics interaction analysis engine 118 can be programmed to generate actionable review comments to a designer (e.g., as opposed to needing interpretation from an expert RF engineer).

The system 100 may include a design modification engine 120. The design modification engine 120 can be configured to receive at least one datum provided by each of the automated machine analysis engine 110, the schematic analysis engine 112, the PCB layout analysis engine 114, the PCB manufacturability analysis engine 116, and the physics interaction analysis engine 118. The design modification engine 120 may be configured to generate at least one of (1) a screen display object 103 on a human-machine interface illustrating the data and (2) a change 104 to at least one of the bill of materials, the schematic diagram, and the PCB layout in response to the at least one datum.

In various aspects, the change 104 to at least one of the bill of materials, the schematic diagram, and the PCB layout can be applied to the PCB design and the modified PCB design can be analyzed by the system 100 in an iterative manner until an acceptable PCB design is generated.

The screen display object 103 can be a screen element or a file object displayed on a human-machine interface (e.g., a screen). The human-machine interface supports position adjustment and size adjustment operations on a display area of the screen display object. For example, the screen display object can include, but is not limited to, text, a schematic, a picture stream, a photo, and/or a video stream.

The system 100 may further include an artificial intelligence (AI) checker 122. The AI checker 122 can receive a modified PCB design 105 (i.e., as modified by the design modification engine 120) from the design modification engine 120 and perform a final check on the modified PCB design 105 to detect errors of, or improvements to, the modified circuit design. The AI checker 122 can send detected errors 106 (which can include suggested improvements) to the design modification engine 120. The design modification engine 120 can perform further modifications to the PCB design based on the received errors 106. The design modification engine 120 can proceed to send the doubly modified PCB design back to the AI checker 122 and the AI checker 122 can again perform a check on the doubly modified PCB design to detect any errors. The design modification engine 120 and the AI checker 122 can proceed in this manner to iteratively improve the PCB circuit design until no more errors are detected by the AI checker 122 (and/or until the AI checker 122 has a threshold confidence in the modified PCB circuit design).

In various embodiments, the AI checker 122 can utilize a machine learning model trained using a large volume of training and testing data sets. The model can be an artificial Neural network model (ANN), a K-Nearest Neighbor (KNN) model, a Support Vector Machine (SVM) model, a Deep Neural Network (DNN) model, a Decision Tree (DT) model, or a Random Forest (Random Trees) model. According to the desired accuracy, an appropriate model can be selected for local optimization.

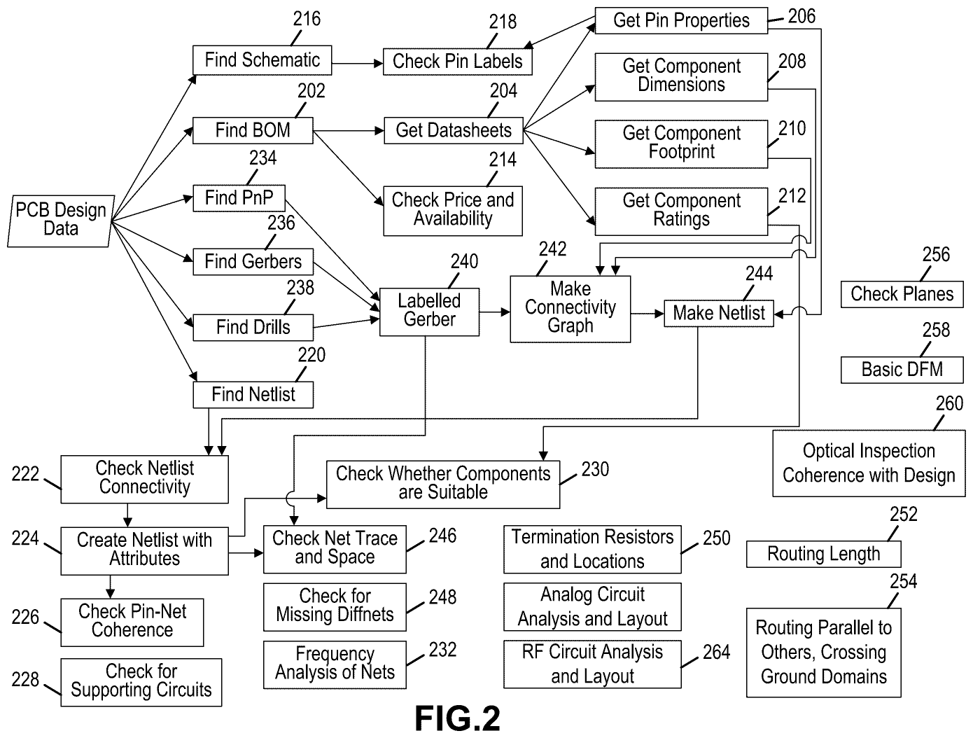

FIG. 2 is a flowchart 200 showing various exemplary steps performed using the system 100 described with respect to FIG. 1. In various aspects, the automated machine analysis engine 110 can sort through PCB design data to find a bill of materials for the PCB (step 202). The automated machine analysis engine 110 can retrieve datasheets related to the bill of materials for the PCB (step 204). The automated machine analysis engine 110 can analyze the datasheets to determine pin properties (step 206), to determine component dimensions (step 208), to determine component footprint (step 210), and/or to determine component ratings (step 212). The automated machine analysis engine 110 can check pricing and availability of parts/components for the PCB design (step 214), for example by using a pricing and availability table saved in memory and/or an internet search.

In various aspects, the schematic analysis engine 112 can sort through the PCB design data to find a PCB schematic (step 216). For example, the PCB design schematic can be in the form of a PDF or other file type. The schematic analysis engine 112 can check pin labels (step 218). Pin labels, often called silkscreen labels, can be text markings printed on the PCB schematic to identify component pins and facilitate assembly, inspection, and troubleshooting. The schematic analysis engine 112 can use the pin properties generated at step 206 by the automated machine analysis engine 110 when checking pin labels.

The schematic analysis engine 112 can further sort through the PCB design data to find a netlist (step 220). The netlist can generally be a list of the electrical connections that describe a circuit. The netlist can have nets with labels and a list of all the components connected to that net. The netlist can contain information regarding components, their designators, pins, and the names of any nets that connect each pin to components. The schematic analysis engine 112 check netlist connectivity (step 222). Step 222 can be performed using the netlist found in step 220. The schematic analysis engine 112 can create a netlist with attributes (step 224), for example using the pin properties generated in step 206. Attributes can include properties or characteristics associated with components, nets, or pins within a netlist, providing information about the circuit's structure and functionality (e.g., designators, component types, values, footprints, net names, net connections, net attributes, pin numbers, pin names, pin connections, pin attributes, etc.).

The schematic analysis engine 112 can check pin-net coherence (step 226). The schematic analysis engine 112 can check for supporting circuits (step 228). The schematic analysis engine 112 can check whether components are suitable (step 230). For example, the schematic analysis engine 112 can check whether the components are compatible. The schematic analysis engine 112 can perform frequency analysis of the nets (step 232). Step 232 can be performed using the netlist with attributes created in step 224.

The PCB layout analysis engine 114 can sort through the PCB design data to find one or more “Pick and Place” or “Peel and Place” files (step 234). Pick and Place files are also sometimes called Component Placement or CPL files. “Pick and place” refers to a robotic assembly process where components are picked from a feeder and placed onto a board, while “peel and place” is a process where components are peeled from a carrier and then placed on a board. The PCB layout analysis engine 114 can sort through the PCB design data to find one or more Gerber files (step 236). The PCB layout analysis engine 114 can sort through the PCB design data to find one or more drill files (step 238). The PCB layout analysis engine 114 can use the PnP file(s), the Geber file(s), and/or the drill file(s) to generate a labelled Gerber file (step 240). The PCB layout analysis engine 114 can use the labelled Gerber file to generate one or more connectivity graphs (step 242). The connectivity graph(s) can represent the PCB design in graphical format. The connectivity graph(s) can include nodes representing each electronic component and links representing each connection. The PCB layout analysis engine 114 can use the component dimensions generated in step 208 and/or the component footprints generated in step 210 to make the connectivity graph.

The PCB layout analysis engine 114 can generate a netlist using the connectivity graph (step 244). The PCB layout analysis engine 114 can use the pin properties generated in step 206 to create the netlist. The netlist made in step 244 can be used for checking whether components are suitable in step 230.

At step 246, the PCB layout analysis engine 114 can check net trace and space using the labelled Gerber file(s) created in step 240 and/or the netlist with attributes created in step 224. At step 248, the PCB layout analysis engine 114 can check for missing diffnets (i.e., differential pair routing). Differential pair routing can be common in high-speed designs (e.g., USB and/or Ethernet). The PCB layout analysis engine 114 can check that the differential pair routing is properly defined and routed according to predetermined differential pair rules. Step 248 can be performed using the PCB design data and/or information generated by one or more of the engines 110, 112, 114, 116, and 118.

In various aspects, the PCB layout analysis engine 114 can check termination resistors and locations (step 250). It can be desirable for certain types of signals to have termination resistors to snub reflections. The PCB layout analysis engine 114 can determine whether the termination resistors are provided in the correct location (e.g., at the end of a transmission line). This check can ensure these resistors exist and that they are at a relevant spot in the circuit. The PCB layout analysis engine 114 can check routing length (step 252). Certain signals might degrade if the routing length of the trace gets too long. This check can ensure that the routing length of one or more traces is not too long. The PCB layout analysis engine 114 can check routing parallel to others and crossing ground domains (step 254). Signals can become corrupted or corrupt others if they are routed parallel or crossing other signals. Signals crossing ground domains might experience corruption due to potential differences between the two domains. This check in step 254 can identify areas of concern where signals were routed in ways that would unnecessarily increase crosstalk and corruption between signals on the board. Digital circuits, analog circuits, and/or RF circuits can be analyzed.

In various aspects, the PCB manufacturability analysis engine 116 checks planes (step 256). A plane can be a ground plan or a power plane. The PCB manufacturability analysis engine 116 can check manufacturability of the plane(s). The PCB manufacturability analysis engine 116 can perform one or more design for manufacturability (DFM) checks at step 258. A DFM check can aide in resolving problems that may arise during fabrication and assembly. Step 258 can include checking each design before the files go for fabrication. DFM checks can point out potential defects in advance and ensure the boards are manufactured to specification. DFM checks can be related to circuit board geometry. At step 258, the PCB manufacturability analysis engine 116 can check for acid traps, solder mask slivers, starved thermals, insufficient antipad (clearance pad) diameter, annular ring tangency and breakout, layer shorting, solder bridges, and/or overlapping silkscreen, among other potential issues. The PCB manufacturability analysis engine 116 can perform optical inspection to ensure coherence with the PCB design (step 260). Optical inspection can include acquiring data points used for visual inspection and precision measurement. An optical inspection system can scan the surface of the PCB. The board can be lit by several light sources and observed by a scanner or by a number of high-definition cameras.

In various aspects, the physics interaction analysis engine 118 can perform RF circuit analysis and layout (step 264).

Infrastructure buildout of the PCB design can include Phase 1 (retrieve datasheets, IC pin database, visualize Gerbers, schematics, and parameters, report wizard), Phase 2 (Gerber analysis (DFM), component footprint analysis, netlist generation, net analysis, auto-constraints), and Phase 3 (supporting circuits, termination resistors and locations, routing length, stubs, planes, frequency analysis).

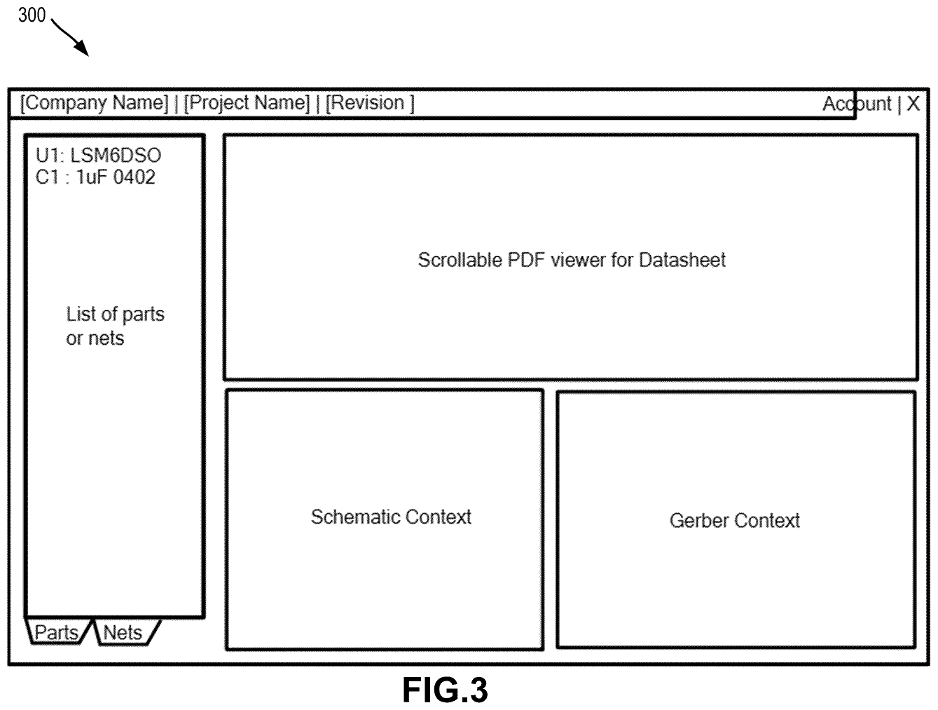

FIG. 3 is an example human-machine interface 300 displaying screen display objects (e.g., see screen display object 103 of FIG. 1) illustrating example data generated by the system 100 described with respect to FIG. 1. In the illustrated embodiment, the screen display objects include company name, project name, revision (e.g., version), a list of parts or nets, a scrollable PDF view for the datasheet, schematic context, and Gerber context.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Systems, methods and apparatus are provided herein. In the detailed description herein, references to “various embodiments,” “one embodiment,” “an embodiment,” “an example embodiment,” “various aspects,” “one aspect,” “an aspect,” “an example aspect,” etc., indicate that the embodiment or aspect described may include a particular feature, structure, or characteristic, but every embodiment or aspect may not necessarily include the particular feature, structure, or characteristic. Moreover, such phrases are not necessarily referring to the same embodiment or aspect. Further, when a particular feature, structure, or characteristic is described in connection with an embodiment or aspect, it is submitted that it is within the knowledge of one skilled in the art to affect such feature, structure, or characteristic in connection with other embodiments or aspects whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is intended to invoke 35 U.S.C. 112(f), unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A computerized system for circuit design review and analysis comprising:
an automated machine analysis engine running in a processor and operable to execute a bill of materials (BOM) evaluation of a printed circuit board (PCB) design;
a schematic analysis engine running in the processor and operable to analyze a schematic diagram associated with the PCB design;
a PCB layout analysis engine running in the processor and operable to analyze a PCB layout associated with the PCB design;
a PCB manufacturability analysis engine running in the processor and operable to analyze the PCB layout of the PCB design in combination with the BOM to validate manufacturability of the PCB design;
a physics interaction analysis engine running in the processor and operable to analyze the PCB design to identify electromagnetic behavior of at least one feature of a simulated manufactured device including the PCB design, wherein the electromagnetic behavior is deleterious; and
a design modification engine running in the processor and configured to:
(i) ingest at least one datum provided by each of the automated machine analysis engine, the schematic analysis engine, the PCB layout analysis engine, the PCB manufacturability analysis engine, and the physics interaction analysis engine; and
(ii) generate at least one of (1) a screen display object on a human-machine interface illustrating the data and (2) a change to at least one of the bill of materials, the schematic diagram, and the PCB layout in response to the at least one datum.

2. The computerized system of claim 1, wherein the design modification engine is further configured to generate a modified PCB design based upon the change to at least one of the bill of materials, the schematic diagram, and the PCB layout.

3. The computerized system of claim 2, further comprising an artificial intelligence (AI) checker running in the processor and operable to:
receive the modified PCB design from the design modification engine; and
detect an error in the modified PCB design using a machine learning model.

4. The computerized system of claim 3, wherein the AI checker is further operable to send the error to the design modification engine.

5. The computerized system of claim 4, wherein the design modification engine is further operable to (1) further modify to the modified PCB design based on the error received from the AI checker to generate a doubly modified PCB design and (2) send the doubly modified PCB design to the AI checker to detect any errors in the doubly modified PCB design.

6. The computerized system of claim 1, wherein the schematic analysis engine is configured to receive a netlist associated with the PCB design, check netlist connectivity using the netlist associated with the PCB design, create a netlist with attributes, and check whether components of the PCB design are compatible based upon the netlist with attributes.

7. The computerized system of claim 6, wherein the PCB layout analysis engine is configured to:
receive a PnP file associated with the PCB design, a Gerber file associated with the PCB design, and a drill file associated with the PCB design;
generate a labelled Gerber file; and
generate a connectivity graph using the labelled Gerber file.

8. A computer-implemented method for circuit design review and analysis, the method comprising:
receiving, by a processor, a PCB design data comprising a bill of materials (BOM) for a PCB design and the PCB design;
evaluating, by the processor, the BOM for the PCB design to generate a first PCB design datum;
analyzing, by the processor, a schematic diagram associated with the PCB design to generate a second PCB design datum;
analyzing, by the processor, a PCB layout associated with the PCB design to generate a third PCB design datum;
analyzing, by the processor, the PCB layout associated with the PCB design in combination with the BOM to validate manufacturability of the PCB design to generate a fourth PCB design datum;
analyzing, by the processor, the PCB design to identify electromagnetic behavior of at least one feature of a simulated manufactured device including the PCB design to generate a fifth PCB design datum, wherein the electromagnetic behavior is deleterious; and
analyzing, by the processor, the first datum, the second datum, the third datum, the fourth datum, and the fifth datum to generate at least one of (1) a screen display object on a human-machine interface illustrating the data and (2) a change to at least one of the bill of materials, the schematic diagram, and the PCB layout in response to the first datum, the second datum, the third datum, the fourth datum, and the fifth datum.

9. The computer-implemented method of claim 8, further comprising generating, by the processor, a modified PCB design based upon the change to at least one of the bill of materials, the schematic diagram, and the PCB layout.

10. The computer-implemented method of claim 9, further comprising detecting, using a machine learning model, an error in the modified PCB design.

11. The computer-implemented method of claim 10, further comprising:
modifying, by the processor, the modified PCB design based on the error to generate a doubly modified PCB design; and
detecting, using the machine learning model, a second error in the doubly modified PCB design.

12. The computer-implemented method of claim 10, further comprising:
receiving a netlist associated with the PCB design;
checking netlist connectivity using the netlist associated with the PCB design;
creating a netlist with attributes; and
checking whether components of the PCB design are compatible based upon the netlist with attributes.

13. The computer-implemented method of claim 10, further comprising:
receiving a PnP file associated with the PCB design, a Gerber file associated with the PCB design, and a drill file associated with the PCB design;
generating a labelled Gerber file; and
generating a connectivity graph using the labelled Gerber file.

14. A non-transitory machine-readable storage medium operable on a computer and comprising instructions that, when executed, cause at least one processor of the computer to:
receive a PCB design data comprising a bill of materials (BOM) for a PCB design and the PCB design;
evaluate the BOM for the PCB design to generate a first PCB design datum;
analyze a schematic diagram associated with the PCB design to generate a second PCB design datum;
analyze a PCB layout associated with the PCB design to generate a third PCB design datum;
analyze the PCB layout associated with the PCB design in combination with the BOM to validate manufacturability of the PCB design to generate a fourth PCB design datum;
analyze the PCB design to identify electromagnetic behavior of at least one feature of a simulated manufactured device including the PCB design to generate a fifth PCB design datum, wherein the electromagnetic behavior is deleterious; and
analyze the first datum, the second datum, the third datum, the fourth datum, and the fifth datum to generate at least one of (1) a screen display object on a human-machine interface illustrating the data and (2) a change to at least one of the bill of materials, the schematic diagram, and the PCB layout in response to the first datum, the second datum, the third datum, the fourth datum, and the fifth datum.

15. The non-transitory machine-readable storage medium of claim 14, wherein the instructions, when executed, further cause the at least one processor of the computer to generate a modified PCB design based upon the change to at least one of the bill of materials, the schematic diagram, and the PCB layout.

16. The non-transitory machine-readable storage medium of claim 15, wherein the instructions, when executed, further cause the at least one processor of the computer to detect, using a machine learning model, an error in the modified PCB design.

17. The non-transitory machine-readable storage medium of claim 16, wherein the instructions, when executed, further cause the at least one processor of the computer to modify the modified PCB design based on the error to generate a doubly modified PCB design.

18. The non-transitory machine-readable storage medium of claim 17, wherein the instructions, when executed, further cause the at least one processor of the computer to detect, using the machine learning model, a second error in the doubly modified PCB design.

19. The non-transitory machine-readable storage medium of claim 15, wherein the instructions, when executed, further cause the at least one processor of the computer to:
receive a netlist associated with the PCB design;
check netlist connectivity using the netlist associated with the PCB design;
create a netlist with attributes; and
check whether components of the PCB design are compatible based upon the netlist with attributes.

20. The non-transitory machine-readable storage medium of claim 15, wherein the instructions, when executed, further cause the at least one processor of the computer to:
receive a PnP file associated with the PCB design, a Gerber file associated with the PCB design, and a drill file associated with the PCB design;
generate a labelled Gerber file; and
generate a connectivity graph using the labelled Gerber file.
